(19) United States
(12) Patent Application Publication
(10) Pub. No.: US 2019/0208279 A1
(43) Pub. Date: Jul. 4, 2019

(54) Connected TV Comments and Reactions

(71) Applicant: Facebook, Inc., Menlo Park, CA (US)

(72) Inventors: Andrew Lawrence Anker, Woodside, CA (US); Michael Paul Mastrangelo, Seattle, WA (US); Ryan Casey, San Francisco, CA (US)

(21) Appl. No.: 15/857,879

(22) Filed: Dec. 29, 2017

(51) Int. Cl. H04N 21/4788; H04N 21/482; H04N 21/431; H04N 21/41; H04N 21/422

(52) U.S. Cl. CPC H04N 21/4788; H04N 21/482; G06F 3/04883; H04N 21/4126; H04N 21/42224; H04N 21/4312

(57) ABSTRACT

In particular embodiments, a system includes a processor operable to receive, from a client device, a user selection of video content to display on a display device that is separate from the client device. The processor is further operable to receive a first user input on a touch-sensitive portion of the client device. The processor is further operable to display, in response to the first user input, a plurality of selectable reactions overlaid on the selected video being displayed on the display device. The processor is further operable to receive a second user input to select one of the selectable reactions. The processor is further operable to display, in response to the second user input, a graphical representation of the selected reaction on the display device, the graphical representation being overlaid on the selected video being displayed on the display device.

### TECHNICAL FIELD

This disclosure relates generally to television and social networking.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a Global Positioning System (GPS) receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments enhance a user's social networking and television viewing experience by overlaying comments and reactions on top of video content currently being viewed. The comments and reactions are related to the video content being viewed and may be input by a user with a client device such as a smartphone or wireless remote control.

In particular embodiments, a display device of a user is utilized to view video content selected by the user. In some embodiments, the video content is provided by a digital media player and is selected using a wireless remote control. In other embodiments, the video content is wirelessly streamed, screencast (“cast” or “casting”), or otherwise provided by a client device. For example, a mobile application running on the user's smartphone may cast or wirelessly stream a video to a digital media player or smart TV for display on the TV. While the video is being displayed on the TV, the user may select a reaction or enter a comment about the video using the client device. The user's selected reaction and comment may then appear overlaid on top of the video content on the display device. For example, the user may enter a comment on their smartphone while it is casting a video to a TV and the comment may appear on top of the video while it is playing. Comments about the video from other users may also appear on top of the video. As another example, the user may utilize a wireless remote control to select a reaction (e.g., like, love, anger, etc.) to the video that is playing on the TV and an icon of the selected reaction may appear on top of the video while it is playing. Reactions to the video from other users may also appear on top of the video. In some embodiments, icons of the reactions may appear to float across the video as it is playing (e.g., from right to left across the screen).

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example environment for providing connected TV comments and reactions.

FIGS. 2A-2D illustrate various interfaces related to connected TV comments and reactions.

FIGS. 3A-3D illustrate various additional interfaces related to connected TV comments and reactions.

FIG. 4 illustrates an example method for providing connected TV comments and reactions.

FIG. 5 illustrates an example network environment associated with a social-networking system.

FIG. 6 illustrates an example social graph.

FIG. 7 illustrates an example computer system.

### DESCRIPTION OF EXAMPLE EMBODIMENTS

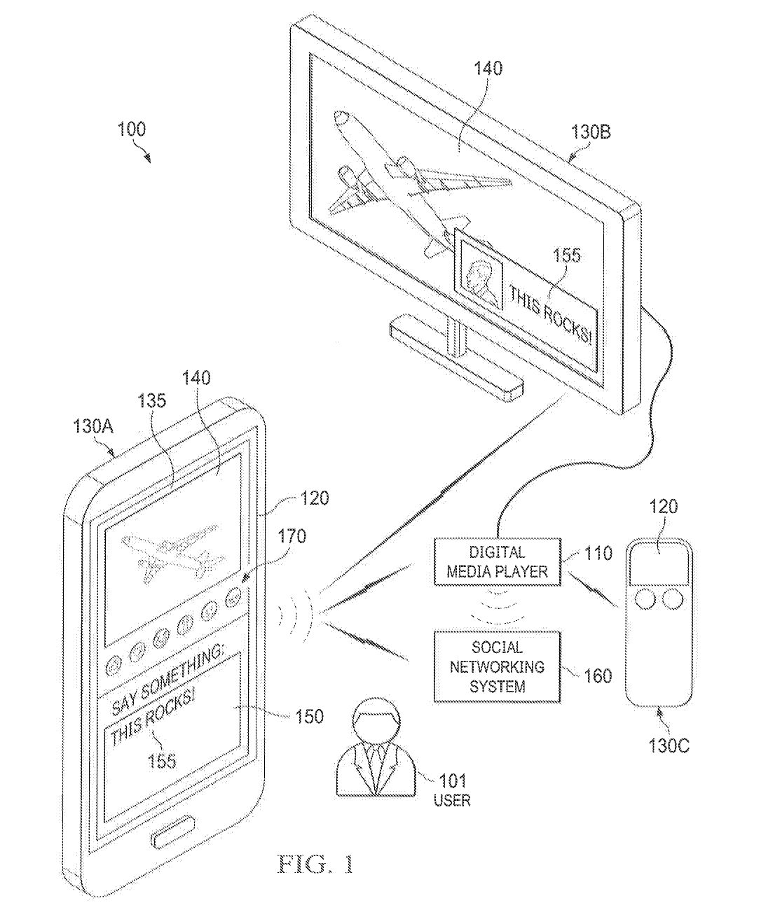

Particular embodiments enhance a user's television and social-networking experience by overlaying comments and reactions on top of video content currently being viewed on, for example, a television (“TV”). The comments and reactions are related to the video content being viewed on the TV and may be input by a user with a client device such as a smartphone or wireless remote control. In a specific embodiment, the video is wirelessly streamed from the client device to the TV or a digital media device connected to the TV. These and other features of the disclosed embodiments are discussed in more detail below with respect to FIGS. 1-7.

FIG. 1 illustrates an example environment for providing connected TV comments and reactions, according to certain embodiments. In general, a user 101 may utilize a client device 130 (e.g., a TV 130B) to view video content 140 selected by the user 101. In some embodiments, video content 140 is provided by a digital media player 110 and is selected using a wireless remote control 130C. In other embodiments, video content 140 is wirelessly streamed, screencast (“cast” or “casting”), or otherwise provided by a client device 130. For example, a mobile application running on a smartphone 130A of user 101 may cast or wirelessly stream video content 140 to digital media player 110 or TV 130B (e.g., a smart TV) for display. While video content 140 is being displayed on TV 130B, user 101 may select a reaction or enter a comment about video content 140 using client device 130A. The user's selected reaction and comment may then appear overlaid on top of video content 140 on TV 130B.

As a specific example, user 101 may enter a comment 155 on their smartphone 130A while it is casting video content 140 to TV 130B, and the comment 155 entered by user 101 may appear on top of the video content 140 while it is playing. Comments 155 about video content 140 from other users 101 (e.g., friends or connections of the user 101 on a social-networking system 160 who are also watching video content 140) may also appear on top of the video content 140 on TV 130B. As another example, user 101 may utilize wireless remote control 130C to select a reaction (e.g., like, love, anger, etc.) to the particular video content 140 that is currently playing on TV 130B, and an icon or graphical element of the selected reaction may appear on top of the video content 140 while it is playing. Reactions to the video content 140 from other users 101 (e.g., friends or connections of the user 101 who is watching video content 140) may also appear on top of the video content 140. In some embodiments, icons of the reactions may appear to float across video content 140 as it is playing (e.g., from right to left across the screen).

In particular embodiments, user 101 may be an individual (human user), an entity (e.g., an enterprise, business, or third-party application), or a group (e.g., of individuals or entities) that interacts or communicates with or over social-networking system 160. In particular embodiments, one or more users 101 may use one or more client devices 130 to access, send data to, and receive data from social-networking system 160 or third-party system (e.g., third-party system 570 described below).

Digital media player 110 may be any computing system, device, microconsole, network appliance, entertainment device, and the like that is capable of receiving digital data from multiple content sources and stream it or otherwise provide it to a capable television such as TV 130B. Digital media player 110 may be any hardware or software that delivers content or possesses a network interface card (NIC) for connecting to a network such as local area network (LAN) or the Internet. For example, digital media player 110 may be a cable box provided by a Multiple System Operator (MSO) such as Comcast, Time Warner, AT&T U-verse, or Dish Network. In such examples, digital media player 110 may receive content from the MSO. As another example, digital media player 110 may be a device that streams video content 140 from third-party internet websites or services such as over-the-top (OTT) providers. Examples of such digital media players 110 include, without limitation, devices from Roku, Boxee, Apple TV, and Google TV that allow users to access content from OTT providers such as NetFlix, Hulu, Amazon Video, YouTube, and the like. In some embodiments, digital media player 110 may be a stand-alone device. In other embodiments, the functionality of digital media player 110 may be incorporated into TV 130B that is connected to the Internet (e.g., a smart TV).

In some embodiments, digital media player 110 provides a graphical user interface (GUI) on client devices 130 such as TV 130B that allows user 101 to select which video content 140 to display on TV 130B. In such embodiments, digital media player 110 may run various applications (“apps”) that are provided by third parties such as OTT providers. For example, social-networking system 160 may provide an app that runs on digital media player 110 and allows user 101 to select video content 140 from social-networking system 160 to display on TV 130B. In some embodiments, user 101 may utilize wireless remote control 130C to interact with the GUI of the app running on digital media player 110 and select which video content 140 to play on TV 130B. In other embodiments, user 101 may utilize any other client device 130 such as smartphone 130A to interact with the GUI of the app running on digital media player 110 in order to select which video content 140 to play on TV 130B.

In some embodiments, digital media player 110 communicates either wirelessly or via a wired connection with social-networking system 160 and various client devices 130 (e.g., smartphone 130A, TV 130B, and wireless remote control 130C). In some embodiments, digital media player 110 communicates directly with such devices. In other embodiments, digital media player 110 communicates with such devices over one or more networks such as network 510 described below.

In particular embodiments, client device 130 may be any appropriate electronic device including hardware, software, or embedded logic components or a combination of two or more such components and capable of carrying out the appropriate functionalities implemented or supported by client device 130. As an example and not by way of limitation, a client device 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client devices 130. A client device 130 may enable user 101 to access a network such as network 510 described below. A client device 130 may enable its user 101 to communicate with other users 101 at other client devices 130. In particular embodiments, client device 130A is a smartphone, client device 130B is a TV, and client device 130C is a wireless remote control.

Touch-sensitive area 120 is any portion of client device 130 that is capable of detecting touch inputs by a human using, for example, a finger or a pointer such as a stylus. As one example, wireless remote control 130C may include a rectangular touch-sensitive area 120 as illustrated in FIG. 1. As another example, smartphone 130A may include a forward-facing screen that functions as its touch-sensitive area 120. Touch-sensitive areas 120 are generally capable of detecting touches and gestures (e.g., swipes in a certain direction) by user 101.

In some embodiments, a mobile app 135 on client device 130 enables user 101 to view and select video content 140 to display on another client device 130. For example, smartphone 130A may run a mobile app 135 that displays videos and other media content that may be selected for viewing on TV 130B. In some embodiments, mobile app 135 may provide a newsfeed or any other content described herein from social-networking system 160. In some embodiments, mobile app 135 may include a comment area 150 that allows user 101 to enter a comment 155. Mobile app 135 may also present reactions 170 for each video content 140 that may be selected by user 101. Examples of reactions 170 are discussed in more detail below.

In some embodiments, comments 155 associated with programs being viewed on TV 130B may be time-stamped to allow the comments 155 to be synced with the program and later viewed at the same point within the program as when the comments 155 were originally posted. For example, many users utilize a DVR to view recorded programs at a later time from when they were originally broadcast. To allow users who are viewing recorded or time-shifted content to also view comments 155 related to the content, some embodiments time-stamp comments 155 and store the comments 155 to be displayed at a later time when video content 140 is being viewed. For example, social networking system 160 may store time-stamped comments 155 in a data repository such as a database. The comments 155 may be time-stamped with, for example, an absolute time (e.g., 02/01/2010 at 23:12) or a time relative to the content associated with the chat message (e.g., 0:16 after the beginning of the program). In addition, some embodiments may store other metadata with the comments 155 such as an identification of the user 101 who posted the comments 155, an identification of the content associated with the comments 155, and the like. Then, when users view video content 140 at a later time, the stored comments 155 related to the content may be retrieved and displayed to the users at the appropriate time in the content. For example, if a particular friend of user 101 made the comment “THIS ROCKS!” during a point of a show, that comment may appear at that same point of the show to users viewing the show at a later time. The comments 155 may appear on smartphone 130A, TV 130B, or both devices concurrently. As a result, users may be able to view relevant comments 155 about the content currently being viewed even if the content is being viewed at a later time from when the content originally aired.

In some embodiments, video content 140 may be any video or media content such as a TV show, a movie, a video clip, a live video, a 360 degree video, and the like. For example, video content 140 may be a video clip that is within a newsfeed in mobile app 135 on smartphone 130A. In other embodiments, video content 140 is a TV show that is selected from a GUI of digital media player 110.

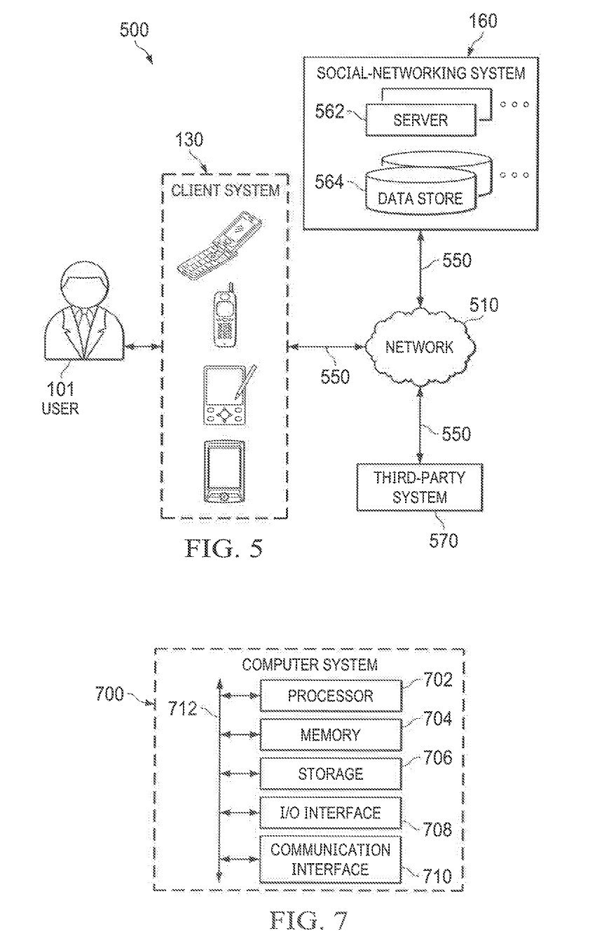

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of a network environment either directly or via a network. As an example and not by way of limitation, client device 130 may access social-networking system 160 using a web browser or a native application associated with social-networking system 160 (e.g., a mobile social-networking application, a messaging application, another suitable application, or any combination thereof) either directly or via a network. Social-networking system 160 is described in more detail below in reference to FIG. 5.

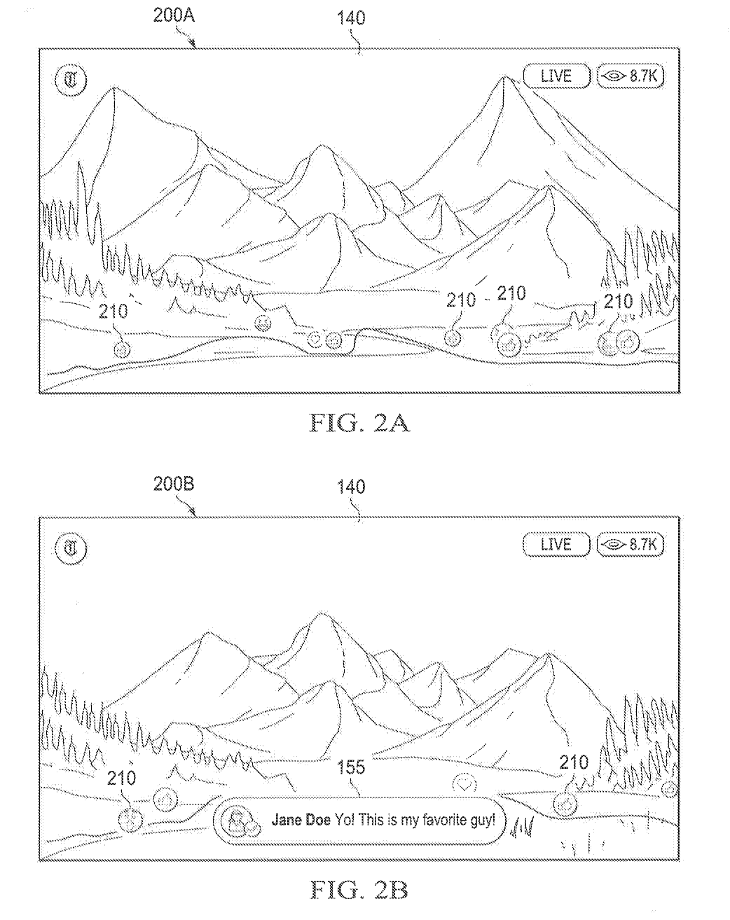

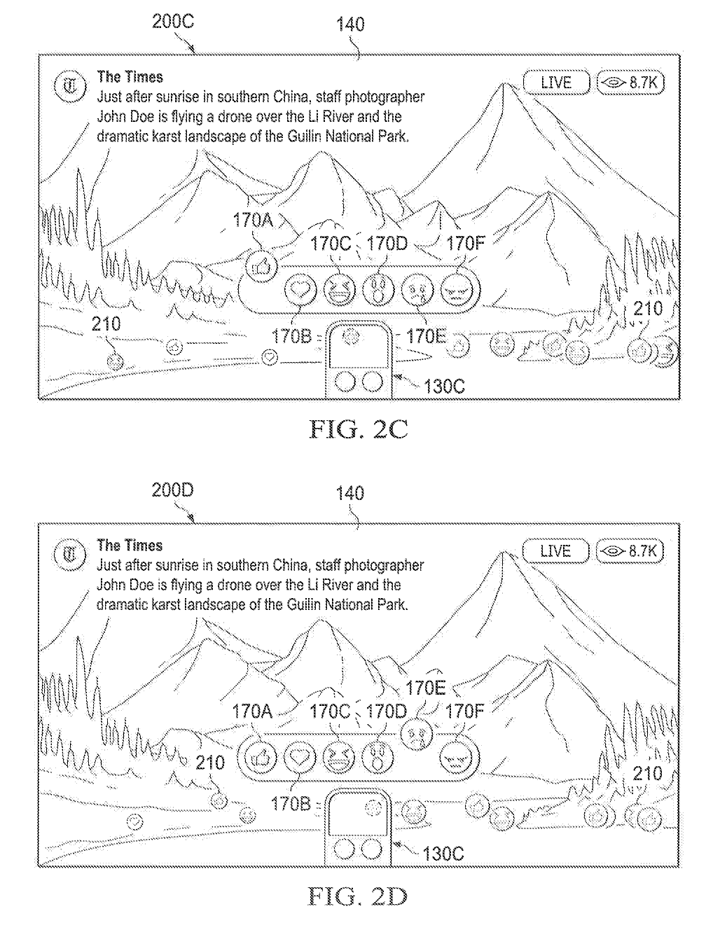

FIGS. 2A-2D illustrate various interfaces (i.e., interfaces 200A-200D) related to connected TV comments and reactions. Interfaces 200 may be displayed to users 101 using any appropriate client device 130. For example, interfaces 200 may be displayed on TV 130B. Interfaces 200 may display selected video content 140 and various GUI elements as described in more detail below.

FIG. 2A illustrates an example interface 200A that includes video content 140 and reaction elements 210. Video content 140, as described above, may be selected by user 101 using any appropriate client device 130, including, for example, smartphone 130A. Reaction elements 210 are any appropriate graphical elements such as icons, badges, pictures, and the like. Reaction elements 210 correspond to reactions 170 selected by users 101. For example, when a particular user 101 selects a particular reaction 170 in, for example, mobile app 135, a reaction element 210 corresponding to the selected reaction 170 may appear overlaid on top of video content 140 as illustrated in FIG. 2A. In some embodiments, reaction elements 210 float across video content 140 (e.g., from right to left) as users 101 select reactions 170.

FIG. 2B illustrates an example interface 200B that additionally includes comment 155. As discussed above, user 101 may enter a particular comment 155 using, for example, comment area 150 within mobile app 135 on smartphone 130A. The entered comment 155 may then appear overlaid on top of video content 140 that is being displayed on TV 130B. In some embodiments, comments 155 from other users of social-networking system 160 may also appear on top of video content 140. The displayed comments 155 may be filtered to only include comments about the displayed video content 140. In some embodiments, the comments 155 that appear on video content 140 may include comments about the displayed video content 140 from all other users 101 of social-networking system 160 or may be filtered to only include comments from connections of user 101 (e.g., friends or other connections as determined from a social graph such as social graph 600).

FIGS. 2C-2D illustrate interfaces 200C and 200D that may include interface elements that permit user 101 to select reactions 170. For example, interfaces 200C and 200D may be displayed on TV 130B and user 101 may utilize any other client device 130 such as smartphone 130A or wireless remote control 130C to select reactions 170. In some embodiments, reactions 170 may include a reaction 170A that indicates that user 101 likes the selected video content 140, a reaction 170B that indicates that user 101 loves the selected video content 140, a reaction 170C that indicates that user 101 thinks the selected video content 140 is funny, a reaction 170D that indicates that user 101 is wowed by the selected video content 140, a reaction 170E that indicates that user 101 is saddened by the selected video content 140, and a reaction 170F that indicates that user 101 is angered by the selected video content 140. While specific reactions 170 have been disclosed, other reactions 170 may be available for selection.

In some embodiments, selectable reactions 170 may be displayed on top of video content 140 in response to one or more touch motions or patterns on touch-sensitive area 120 by user 101. As an example, user 101 may make a first motion on touch-sensitive area 120 of wireless remote control 130C in order to display reactions 170 on top of video content 140 playing on TV 130B. The first motion may be, for example, a press and hold on touch-sensitive area 120 or a swipe in a certain direction across touch-sensitive area 120. FIG. 2C illustrates an example of reactions 170 being displayed in response to the first motion on touch-sensitive area 120 by user 101. Once reactions 170 are displayed on video content 140, user 101 may then make a second motion on touch-sensitive area 120 in order to select one of the reactions 170. For example, user 101 may swipe left or right across touch-sensitive area 120 until the appropriate reaction 170 is highlighted or otherwise selected. User 101 may then pause their motion and lift their finger or stylus off of touch-sensitive area 120 to indicate their final selection. FIG. 2D illustrates an example of reaction 170E being emphasized (e.g., enlarged) in response to the second motion on touch-sensitive area 120 by user 101. Once a particular reaction 170 is selected, the unselected reactions 170 may disappear and the selected reaction 170 (e.g., reaction 170E in this example) may remain in one position for a period of time and may change in appearance (e.g., further enlarge). After a period of time, the selected reaction 710 may disappear or float away with other reaction elements 210. In addition, once a particular reaction 170 is selected, an edge between a node of user 101 and a node of the video content 140 may be added to a social graph such as social graph 600. The added edge corresponds to the selected reaction 170. For example, if user 101 selects reaction 170E that indicates that user 101 is saddened by the selected video content 140, a “sad” edge may be added to the social graph.

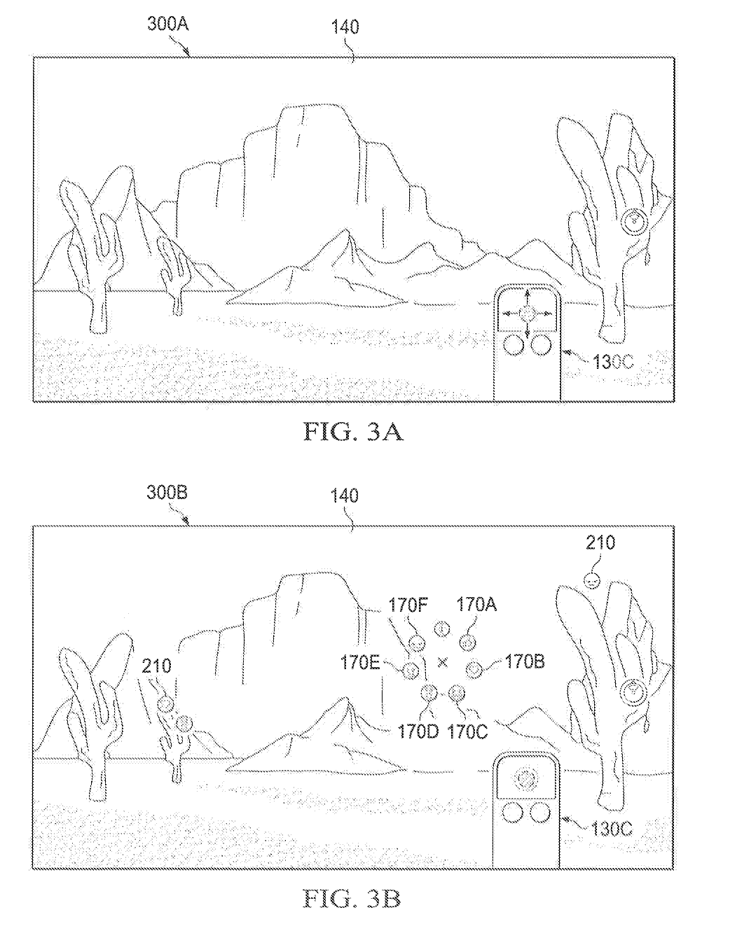

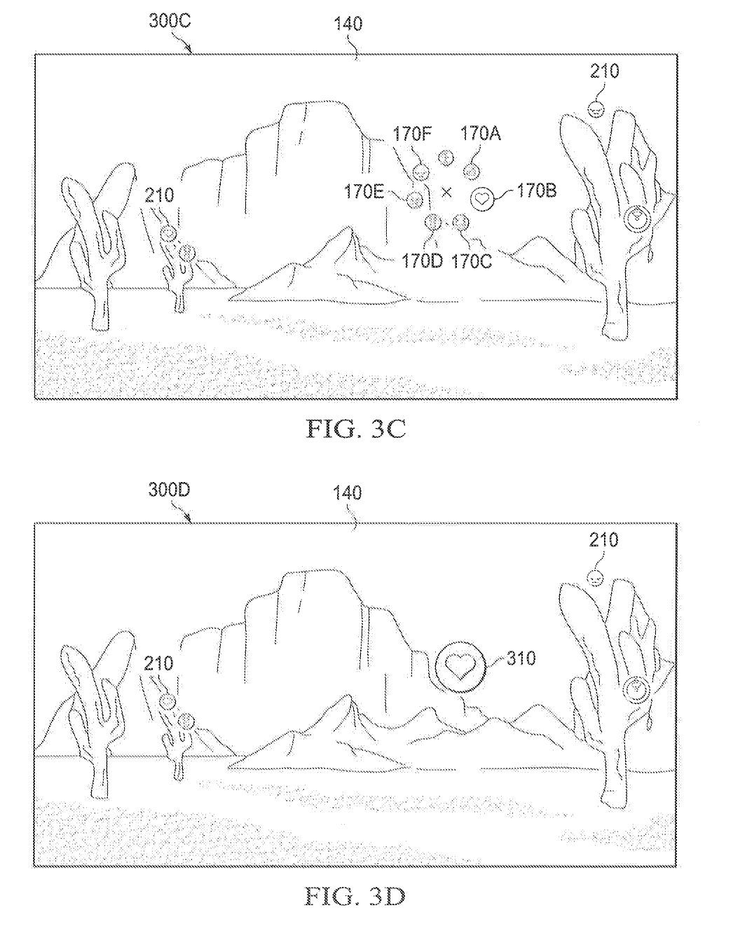

In some embodiments, reactions 170 may be displayed in a horizontal row as illustrated in FIGS. 2C-2D. In other embodiments, reactions 170 may be displayed in any other appropriate pattern such as a vertical column. In some embodiments, reactions 170 may be displayed in a circular pattern as illustrated in FIGS. 3A-3D, which are discussed in more detail below.

FIGS. 3A-3D illustrate interfaces 300A-300D that may include alternative interface elements that permit user 101 to select reactions 170. In some embodiments, video content 140 as illustrated in FIGS. 3A-3D may be a 360 degree video, but are not limited to such. In some embodiments, as illustrated in FIG. 3A, reaction elements 210 may not initially appear within video content 140. Once user 101 makes a first motion on touch-sensitive area 120 (e.g., on wireless remote control 130C), reaction elements 210 and selectable reactions 170 may appear on video content 140 as illustrated in FIG. 3B. Similar to FIGS. 2A-2D, the first motion may be, for example, a press and hold on touch-sensitive area 120 or a swipe in a certain direction across touch-sensitive area 120. In some embodiments, selectable reactions 170 may appear in a circular pattern as illustrated, but also may be in any other appropriate pattern or design. Once reactions 170 are displayed on video content 140, user 101 may then make a second motion on touch-sensitive area 120 in order to select one of the reactions 170. For example, user 101 may make a circular swipe on touch-sensitive area 120 until the appropriate reaction 170 is selected. FIG. 3C illustrates an example of reaction 170B being emphasized (e.g., enlarged) in response to the second motion on touch-sensitive area 120 by user 101. Once a particular reaction 170 is selected, the unselected reactions 170 may disappear and the selected reaction 310 (e.g., reaction 170B in this example) may stay in contextual space for a period of time and may change in appearance (e.g., further enlarge). After a period of time, selected reaction 310 and the other reaction elements 210 may all disappear.

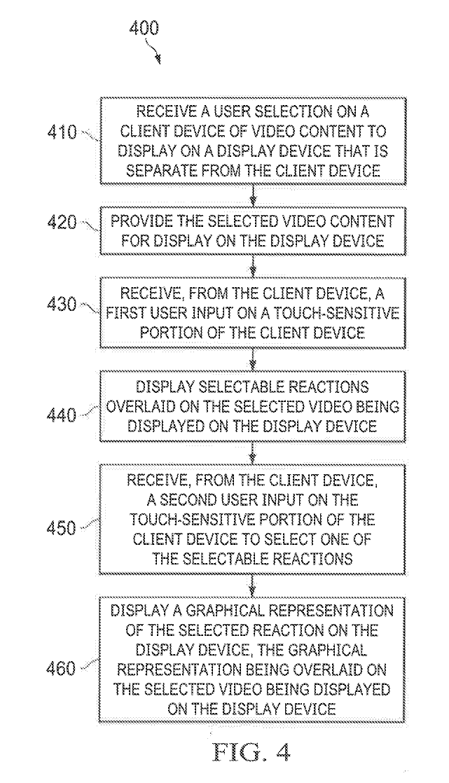

FIG. 4 illustrates an example method 400 for providing connected TV comments and reactions. One or more steps of method 400 may be performed by one or more systems of social networking system 160, client device 130, digital media player 110, or any other appropriate system, device, or software.

Method 400 may begin at step 410, where a computing system receives, from a client device, a user selection of video content to display on a display device that is separate from the client device. In some embodiments, the computing device is a digital media player such as digital media player 110 that is communicatively coupled to the display device. In other embodiments, the computing device is integrated within the display device (e.g., within an internet-connected TV). In some embodiments, the computing device is any server or computing system of social-networking system 160. In some embodiments, the client device is client device 130 and may be a smartphone (e.g., smartphone 130A), a tablet computer, a wireless remote control (e.g., wireless remote control 130C), or any other appropriate user device. In some embodiments, the display device is any client device 130 such as TV 130B. In some embodiments, the user selection of video content to display on the display device in step 410 is made by a user using a mobile application such as mobile app 135 that is running on the client device.

At step 420, the selected video content is provided for display on the display device. In some embodiments, the selected video content is video content 140. In some embodiments, the selected video content is wirelessly streamed by a client device 130 such as smartphone 130A. In other embodiments, the selected video content is provided via the Internet.

At step 430, the computing system receives, from the client device, a first user input on a touch-sensitive portion of the client device. In some embodiments, the first user input is a first user motion on the touch-sensitive portion of the client device. In some embodiments, the touch-sensitive portion is touch-sensitive area 120. In some embodiments, the first user motion is a press and hold on the touch-sensitive portion of the client device. In other embodiments, the first user motion is a swipe (e.g., up or down) on the touch-sensitive portion of the client device.

At step 440, a plurality of selectable reactions are displayed by the computing system in response to the first user motion on the touch-sensitive portion of the client device. In some embodiments, the selectable reactions are overlaid on the selected video being displayed on the display device. In some embodiments, each reaction indicates an emotion by the user in response to the selected video. In some embodiments, the plurality of selectable reactions include a reaction that indicates the user likes the selected video content, a reaction that indicates the user loves the selected video content, a reaction that indicates the user thinks the selected video content is funny, a reaction that indicates the user is wowed by the selected video content, a reaction that indicates the user is saddened by the selected video content, and a reaction that indicates the user is angered by the selected video content. In some embodiments, the plurality of selectable reactions are displayed in a circular pattern, a horizontal row, or a vertical column.

At step 450, the computing system receives, from the client device, a second user input on the touch-sensitive portion of the client device to select one of the selectable reactions. In some embodiments, the second user input is a second user motion on the touch-sensitive portion of the client device. In some embodiments, the second motion is a circular swipe on the touch-sensitive portion of the client device. In some embodiments, the second motion is a swipe (e.g., left or right) on the touch-sensitive portion of the client device.

At step 460, a graphical representation of the selected reaction is displayed on the display device. In some embodiments, the graphical representation is overlaid on the selected video being displayed on the display device. In some embodiments, an edge corresponding to the selected reaction is added in a social graph between a node of the user and a node of the selected video content in response to the second motion by the user on the touch-sensitive portion of the client device. After step 460, method 400 may end.

Some embodiments of method 400 may include additional step(s) for displaying a comment on the selected video being displayed on the display device. In such embodiments, the comment is about the selected video and may be created by the user using a graphical user interface of the client device. In some embodiments, the comment is comment 155 and is input using comment area 150.

Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for scheduling live videos including the particular steps of the method of FIG. 4, this disclosure contemplates any suitable method for scheduling live videos including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

FIG. 5 illustrates an example network environment 500 associated with a social-networking system. Network environment 500 includes a user 101, a client device 130, a social-networking system 160, and a third-party system 570 connected to each other by a network 510. Although FIG. 5 illustrates a particular arrangement of user 101, client device 130, social-networking system 160, third-party system 570, and network 510, this disclosure contemplates any suitable arrangement of user 101, client device 130, social-networking system 160, third-party system 570, and network 510. As an example and not by way of limitation, two or more of client devices 130, social-networking system 160, and third-party system 570 may be connected to each other directly, bypassing network 510. As another example, two or more of client devices 130, social-networking system 160, and third-party system 570 may be physically or logically co-located with each other in whole or in part. Moreover, although FIG. 5 illustrates a particular number of users 101, client devices 130, social-networking systems 160, third-party systems 570, and networks 510, this disclosure contemplates any suitable number of users 101, client devices 130, social-networking systems 160, third-party systems 570, and networks 510. As an example and not by way of limitation, network environment 500 may include multiple client devices 130, social-networking systems 160, third-party systems 570, and networks 510.

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 may connect client device 130, social-networking system 160, and third-party system 570 to communication network 510 or to each other. This disclosure contemplates any suitable links 550. In particular embodiments, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 500 either directly or via network 510. As an example and not by way of limitation, client device 130 may access social-networking system 160 using a web browser or a native application associated with social-networking system 160 (e.g., a mobile social-networking application, a messaging application, another suitable application, or any combination thereof) either directly or via network 510. In particular embodiments, social-networking system 160 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 562 may include hardware, software, or embedded logic components or a combination of two or more such components for carrying out the appropriate functionalities implemented or supported by server 562. In particular embodiments, social-networking system 160 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client device 130, a social-networking system 160, or a third-party system 570 to manage, retrieve, modify, add, or delete, the information stored in data store 564.

In particular embodiments, social-networking system 160 may store one or more social graphs (e.g., social graph 600) in one or more data stores 564. In particular embodiments, a social graph may include multiple nodes-which may include multiple user nodes (each corresponding to a particular user 101) or multiple concept nodes (each corresponding to a particular concept)—and multiple edges connecting the nodes. Social-networking system 160 may provide users 101 of the online social network the ability to communicate and interact with other users 101. In particular embodiments, users 101 may join the online social network via social-networking system 160 and then add connections (e.g., relationships) to a number of other users 101 of social-networking system 160 to whom they want to be connected. Herein, the term “friend” may refer to any other user 101 of social-networking system 160 with whom a user 101 has formed a connection, association, or relationship via social-networking system 160.

In particular embodiments, social-networking system 160 may provide users 101 with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 570, which is separate from social-networking system 160 and coupled to social-networking system 160 via a network 510.

In particular embodiments, social-networking system 160 may be capable of linking a variety of entities. As an example and not by way of limitation, social-networking system 160 may enable users to interact with each other as well as receive content from third-party systems 570 or other entities, or to allow users to interact with these entities through an application programming interfaces (API) or other communication channels.

In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating social-networking system 160. In particular embodiments, however, social-networking system 160 and third-party systems 570 may operate in conjunction with each other to provide social-networking services to users of social-networking system 160 or third-party systems 570. In this sense, social-networking system 160 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client device 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client device 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client devices 130 or one or more third-party system 570 via network 510. The web server may include a mail server or other messaging functionality for receiving and routing messages between social-networking system 160 and one or more client devices 130. An API-request server may allow a third-party system 570 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client device 130. Information may be pushed to a client device 130 as notifications, or information may be pulled from client device 130 responsive to a request received from client device 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 570), such as, for example, by setting appropriate privacy settings. Third-party-content-object stores may be used to store content objects received from third parties, such as a third-party system 570. Location stores may be used for storing location information received from client devices 130 associated with users. Advertisement-pricing modules may combine social information, the current time, location information, or other suitable information to provide relevant advertisements, in the form of notifications, to a user.

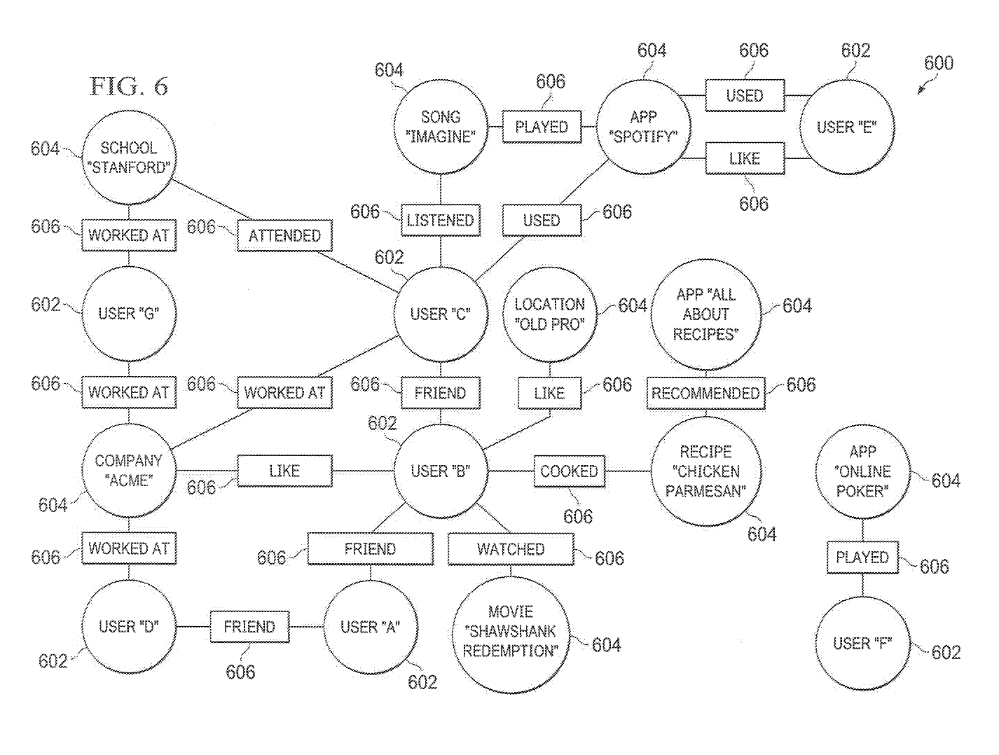

FIG. 6 illustrates example social graph 600. In particular embodiments, social-networking system 160 may store one or more social graphs 600 in one or more data stores. In particular embodiments, social graph 600 may include multiple nodes-which may include multiple user nodes 602 or multiple concept nodes 604—and multiple edges 606 connecting the nodes. Example social graph 600 illustrated in FIG. 6 is shown, for didactic purposes, in a two-dimensional visual map representation. In particular embodiments, a social-networking system 160, client device 130, or third-party system 570 may access social graph 600 and related social-graph information for suitable applications. The nodes and edges of social graph 600 may be stored as data objects, for example, in a data store (such as a social-graph database). Such a data store may include one or more searchable or queryable indexes of nodes or edges of social graph 600.

In particular embodiments, a user node 602 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 602 corresponding to the user, and store the user node 602 in one or more data stores. Users and user nodes 602 described herein may, where appropriate, refer to registered users and user nodes 602 associated with registered users. In addition or as an alternative, users and user nodes 602 described herein may, where appropriate, refer to users that have not registered with social-networking system 160. In particular embodiments, a user node 602 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 602 may be associated with one or more data objects corresponding to information associated with a user. In particular embodiments, a user node 602 may correspond to one or more webpages.

In particular embodiments, a concept node 604 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 604 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 604 may be associated with one or more data objects corresponding to information associated with concept node 604. In particular embodiments, a concept node 604 may correspond to one or more webpages.

In particular embodiments, a node in social graph 600 may represent or be represented by a webpage (which may be referred to as a “profile page”). Profile pages may be hosted by or accessible to social-networking system 160. Profile pages may also be hosted on third-party websites associated with a third-party system 570. As an example and not by way of limitation, a profile page corresponding to a particular external webpage may be the particular external webpage and the profile page may correspond to a particular concept node 604. Profile pages may be viewable by all or a selected subset of other users. As an example and not by way of limitation, a user node 602 may have a corresponding user-profile page in which the corresponding user may add content, make declarations, or otherwise express himself or herself. As another example and not by way of limitation, a concept node 604 may have a corresponding concept-profile page in which one or more users may add content, make declarations, or express themselves, particularly in relation to the concept corresponding to concept node 604.

In particular embodiments, a concept node 604 may represent a third-party webpage or resource hosted by a third-party system 570. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client device 130 to send to social-networking system 160 a message indicating the user's action. In response to the message, social-networking system 160 may create an edge (e.g., a check-in-type edge) between a user node 602 corresponding to the user and a concept node 604 corresponding to the third-party webpage or resource and store edge 606 in one or more data stores.

In particular embodiments, a pair of nodes in social graph 600 may be connected to each other by one or more edges 606. An edge 606 connecting a pair of nodes may represent a relationship between the pair of nodes. In particular embodiments, an edge 606 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 606 connecting the first user's user node 602 to the second user's user node 602 in social graph 600 and store edge 606 as social-graph information in one or more of data stores 564. In the example of FIG. 6, social graph 600 includes an edge 606 indicating a friend relation between user nodes 602 of user “A” and user “B” and an edge indicating a friend relation between user nodes 602 of user “C” and user “B.” Although this disclosure describes or illustrates particular edges 606 with particular attributes connecting particular user nodes 602, this disclosure contemplates any suitable edges 606 with any suitable attributes connecting user nodes 602. As an example and not by way of limitation, an edge 606 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 600 by one or more edges 606.

In particular embodiments, an edge 606 between a user node 602 and a concept node 604 may represent a particular action or activity performed by a user associated with user node 602 toward a concept associated with a concept node 604. As an example and not by way of limitation, as illustrated in FIG. 6, a user may “like,” “attended,” “played,” “listened,” “cooked,” “worked at,” or “watched” a concept, each of which may correspond to an edge type or subtype. A concept-profile page corresponding to a concept node 604 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 606 and a “used” edge (as illustrated in FIG. 6) between user nodes 602 corresponding to the user and concept nodes 604 corresponding to the song and application to indicate that the user listened to the song and used the application. Moreover, social-networking system 160 may create a “played” edge 606 (as illustrated in FIG. 6) between concept nodes 604 corresponding to the song and the application to indicate that the particular song was played by the particular application. In this case, “played” edge 606 corresponds to an action performed by an external application (SPOTIFY) on an external audio file (the song “Imagine”). Although this disclosure describes particular edges 606 with particular attributes connecting user nodes 602 and concept nodes 604, this disclosure contemplates any suitable edges 606 with any suitable attributes connecting user nodes 602 and concept nodes 604. Moreover, although this disclosure describes edges between a user node 602 and a concept node 604 representing a single relationship, this disclosure contemplates edges between a user node 602 and a concept node 604 representing one or more relationships. As an example and not by way of limitation, an edge 606 may represent both that a user likes and has used at a particular concept. Alternatively, another edge 606 may represent each type of relationship (or multiples of a single relationship) between a user node 602 and a concept node 604 (as illustrated in FIG. 6 between user node 602 for user “E” and concept node 604 for “SPOTIFY”).

In particular embodiments, social-networking system 160 may create an edge 606 between a user node 602 and a concept node 604 in social graph 600. As an example and not by way of limitation, a user viewing a concept-profile page (such as, for example, by using a web browser or a special-purpose application hosted by the user's client device 130) may indicate that he or she likes the concept represented by the concept node 604 by clicking or selecting a “Like” icon, which may cause the user's client device 130 to send to social-networking system 160 a message indicating the user's liking of the concept associated with the concept-profile page. In response to the message, social-networking system 160 may create an edge 606 between user node 602 associated with the user and concept node 604, as illustrated by “like” edge 606 between the user and concept node 604. In particular embodiments, social-networking system 160 may store an edge 606 in one or more data stores. In particular embodiments, an edge 606 may be automatically formed by social-networking system 160 in response to a particular user action. As an example and not by way of limitation, if a first user uploads a picture, watches a movie, or listens to a song, an edge 606 may be formed between user node 602 corresponding to the first user and concept nodes 604 corresponding to those concepts. Although this disclosure describes forming particular edges 606 in particular manners, this disclosure contemplates forming any suitable edges 606 in any suitable manner.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 570 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 570, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 570, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 600, social-networking system 160 may analyze the number and/or type of edges 606 connecting particular user nodes 602 and concept nodes 604 when calculating a coefficient. As an example and not by way of limitation, user nodes 602 that are connected by a spouse-type edge (representing that the two users are married) may be assigned a higher coefficient than a user nodes 602 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 600. As an example and not by way of limitation, social-graph entities that are closer in the social graph 600 (i.e., fewer degrees of separation) may have a higher coefficient than entities that are further apart in the social graph 600.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client device 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 570 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (IHDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HI)Ds), hybrid hard drives (I-HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing system, receiving, from a client device, a user selection of video content to display on a display device that is separate from the client device;
by the computing system, providing the selected video content for display on the display device;
by the computing system, receiving, from the client device, a first user input on a touch-sensitive portion of the client device;
by the computing system, in response to the first user input, displaying a plurality of selectable reactions overlaid on the selected video content being displayed on the display device, each reaction indicating an emotion;
by the computing system, receiving, from the client device, a second user input on the touch-sensitive portion of the client device to select one of the selectable reactions; and
by the computing system, in response to the second user input:
displaying a graphical representation of the selected reaction on the display device, the graphical representation being overlaid on the selected video being displayed on the display device; and
adding an edge in a social graph between a node of the user and a node of the selected video content, the edge corresponding to the selected reaction.

2. The method of claim 1, wherein:
the client device comprises a smartphone or a tablet computer;
the display device comprises a television; and
the selection by the user of video content to display on the display device is made using a mobile application running on the client device.

3. The method of claim 1, wherein:
the client device comprises a wireless remote control; and
the display device comprises a television.

4. The method of claim 1, wherein the plurality of selectable reactions comprises:
a reaction that indicates the user likes the selected video content;
a reaction that indicates the user loves the selected video content;
a reaction that indicates the user thinks the selected video content is funny;
a reaction that indicates the user is wowed by the selected video content;
a reaction that indicates the user is saddened by the selected video content; and/or
a reaction that indicates the user is angered by the selected video content.

5. The method of claim 1, wherein:
the plurality of selectable reactions are displayed in a circular pattern;
the first user input is a press and hold on the touch-sensitive portion of the client device; and
the second user input is a circular swipe on the touch-sensitive portion of the client device.

6. The method of claim 1, wherein:
the plurality of selectable reactions are displayed in a horizontal row;
the first user input is a swipe up or swipe down on the touch-sensitive portion of the client device; and
the second user input is a swipe left or swipe right on the touch-sensitive portion of the client device.

7. The method of claim 1, wherein:
the computing system is a digital media player communicatively coupled to the display device; or
the computing system is integrated within the display device.

8. The method of claim 1, further comprising:
by the computing system, displaying a comment overlaid on the selected video being displayed on the display device, wherein:
the comment is associated with the selected video; and
the comment is created by the user using a graphical user interface of the client device.

9. One or more computer-readable non-transitory storage media in a computing system, the media embodying logic that is operable when executed to:
receive, from a client device, a user selection of video content to display on a display device that is separate from the client device;
provide the selected video content for display on the display device;
receive, from the client device, a first user input on a touch-sensitive portion of the client device;
in response to the first user input, display a plurality of selectable reactions overlaid on the selected video content being displayed on the display device, each reaction indicating an emotion;
receive, from the client device, a second user input on the touch-sensitive portion of the client device to select one of the selectable reactions; and
in response to the second user input, display a graphical representation of the selected reaction on the display device, the graphical representation being overlaid on the selected video being displayed on the display device.

10. The media of claim 9, wherein:
the client device comprises a smartphone or a tablet computer;
the display device comprises a television; and
the selection by the user of video content to display on the display device is made using a mobile application running on the client device.

11. The media of claim 9, wherein:
the client device comprises a wireless remote control; and
the display device comprises a television.

12. The media of claim 9, wherein the plurality of selectable reactions comprises:
a reaction that indicates the user likes the selected video content;
a reaction that indicates the user loves the selected video content;
a reaction that indicates the user thinks the selected video content is funny;
a reaction that indicates the user is wowed by the selected video content;
a reaction that indicates the user is saddened by the selected video content; and/or
a reaction that indicates the user is angered by the selected video content.

13. The media of claim 9, wherein:
the plurality of selectable reactions are displayed in a circular pattern;
the first user input is a press and hold on the touch-sensitive portion of the client device; and
the second user input is a circular swipe on the touch-sensitive portion of the client device.

14. The media of claim 9, wherein:
the plurality of selectable reactions are displayed in a horizontal row;
the first user input is a swipe up or swipe down on the touch-sensitive portion of the client device; and
the second user input is a swipe left or swipe right on the touch-sensitive portion of the client device.

15. The media of claim 9, wherein:
the computing system is a digital media player communicatively coupled to the display device; or
the computing system is integrated within the display device.

16. The media of claim 9, the logic further operable when executed to:
display a comment overlaid on the selected video being displayed on the display device, wherein:
the comment is associated with the selected video; and
the comment is created by the user using a graphical user interface of the client device.

17. A system, comprising:
one or more memory devices; and
a processor communicatively coupled to the one or more memory devices, the processor operable to:
receive, from a client device, a user selection of video content to display on a display device that is separate from the client device;
provide the selected video content for display on the display device;
receive, from the client device, a first user input on a touch-sensitive portion of the client device;
in response to the first user input, display a plurality of selectable reactions overlaid on the selected video content being displayed on the display device, each reaction indicating an emotion;
receive, from the client device, a second user input on the touch-sensitive portion of the client device to select one of the selectable reactions; and
in response to the second user input, display a graphical representation of the selected reaction on the display device, the graphical representation being overlaid on the selected video being displayed on the display device.

18. The system of claim 17, wherein:
the client device comprises a smartphone or a tablet computer;
the display device comprises a television; and
the selection by the user of video content to display on the display device is made using a mobile application running on the client device.

19. The system of claim 17, wherein:
the client device comprises a wireless remote control; and
the display device comprises a television.

20. The system of claim 17, the processor further operable to:
display a comment overlaid on the selected video being displayed on the display device, wherein:
the comment is associated with the selected video; and
the comment is created by the user using a graphical user interface of the client device.
